(19) United States
(12) Patent Application Publication
(10) Pub. No.: US 2015/0251136 A1
(43) Pub. Date: Sep. 10, 2015

(54) Formaldehyde Emission Reduction in Natural Gas Fired Reciprocating Internal Combustion Engines (RICE)

(71) Applicant: Prism Analytical Technologies, Inc., Mt. Pleasant, MI (US)

(72) Inventor: Martin L. Spartz, Ellington, CT (US)

(21) Appl. No.: 14/636,725

(22) Filed: Mar. 3, 2015

Related U.S. Application Data
(60) Provisional application No. 61/947,568, filed on Mar. 4, 2014.

(51) Int. Cl. B01D 53/94; F01N 13/00

(52) U.S. Cl. CPC B01D 53/9495; B01D 53/9477; F01N 13/0093; B01D 2255/102

(57) ABSTRACT

Exhaust from an NG fired stationary or non-stationary RICE, such as, for example, a lean burn RICE, is directed to a first oxidation catalyst, then to a second oxidation catalyst. The second oxidation catalyst is operated at a temperature higher than a minimum temperature required to oxidize formaldehyde (to CO₂ and H₂O) and lower than a minimum temperature required to form formaldehyde, e.g., from CH₄ and O₂.

### RELATED APPLICATIONS

This application claims the benefit under 35 USC 119(e) of U.S. Provisional Application No. 61/947,568, filed on Mar. 4, 2014, which is incorporated herein by reference in its entirety.

### BACKGROUND OF THE INVENTION

Reciprocating internal combustion engines (RICE) utilize pistons that move back and forth to convert pressure into rotating motion. These engines are commonly used in non-stationary applications such as vehicles (e.g., cars, buses, and trucks), construction and mining equipment, and vessels (e.g., ships and boats) and in stationary applications such as at power and manufacturing plants to generate electricity and to power pumps and compressors, in the oil and gas industry, during emergencies to produce electricity, e.g., to pump water for flood and fire control, and in many other applications. In some cases, the fuel used to run RICE is pressurized or liquefied natural gas (NG) or methane.

Methane (CH₄) is a major component of NG. During combustion, any portion of CH₄ that is not fully oxidized to CO₂ and H₂O can generate atmospheric contaminants, in particular formaldehyde (HCOH) and carbon monoxide (CO). Some existing practices for addressing these air pollutants rely on oxidation catalysts added to the hot (700-1200° F.) exhaust train of a RICE. With sufficient oxygen (O₂) present (as is typically found in lean burn situations) it is generally believed that any HCOH and CO are oxidized to CO₂ and H₂O.

### SUMMARY OF THE INVENTION

Contrary to conventional thinking, it was discovered that a significant amount of formaldehyde (also referred to as HCOH or CH₂O; CAS Registry Number 50-00-0) could be detected even after treating the exhaust from NG-fired stationary RICE, in particular lean burn RICE, with the catalytic oxidation described above even if low CO and VOC concentrations are observed.

A need exists, therefore, for equipment and techniques that can reduce atmospheric contaminants such as HCOH and CO generated in RICE-based systems. In particular, there is a need for decreasing or minimizing levels of HCOH generated by NG fired stationary and non-stationary RICE that utilize traditional arrangements for the catalytic oxidation of HCOH and CO.

In many of its aspects, the invention relates to a method and system for reducing HCOH emissions from an NG or methane fired stationary RICE. The method and system involve oxidizing CO and HCOH present in exhaust generated by RICE, followed by oxidizing HCOH found in the exhaust after the first oxidation.

For example, in a system and method described herein, exhaust from an NG or methane fired stationary RICE, such as, for example, a lean burn RICE, is directed to a first oxidation catalyst, then to a second oxidation catalyst.

Typically, the first oxidation catalyst is operated at a temperature above a minimum temperature required for the oxidation of CO (and also that of HCOH). When placed in the exhaust pathway from the RICE, the first oxidation catalyst can be exposed to temperatures within the range of from about 700° F. to about 1200° F.

In many of the embodiments described herein, the second oxidation catalyst is maintained at a temperature lower than a minimum temperature needed to form HCOH (e.g., from CH₄ and O₂) and higher than a minimum temperature required for the oxidization of HCOH, to form CO₂ and H₂O. When placed in the exhaust pathway of the RICE, the second oxidation catalyst can be exposed to a temperature within the range of from about 350° F. (and possibly lower) to about 700° F. Much higher temperatures such as 1100° F. or higher could be utilized as well but getting the catalyst to that temperature would add further costs and generate unwanted byproducts.

In one implementation, a method for reducing HCOH emissions from an NG or methane fired stationary RICE, comprises: directing exhaust from the NG or methane fired stationary RICE to a first oxidation catalyst, then to a second oxidation catalyst. The second oxidation catalyst is operated at a temperature that is above a minimum temperature required for the oxidation of HCOH, and below a minimum temperature required to form HCOH.

In another implementation, an NG or methane fired stationary RICE system comprises a lean burn NG or methane fired stationary RICE; a first oxidation catalyst disposed in a pathway for exhausting products of combustion from the NG or methane fired stationary RICE and a second oxidation catalyst disposed in said pathway, downstream from the first oxidation catalyst.

In general according to one aspect, the invention features a method for reducing HCOH emissions from an NG or methane fired stationary RICE. The method comprises directing exhaust from the NG or methane fired stationary RICE to a first oxidation catalyst, then to a second oxidation catalyst, in which the second oxidation catalyst is operated at a temperature that is above a minimum temperature required for the oxidation of HCOH, and below a minimum temperature required to form HCOH.

In some embodiments, the NG or methane fired stationary RICE is a lean burn engine.

Typically, the second oxidation catalyst is exposed to exhaust at a temperature within the range of from about 350° F. to about 700° F. The secondary oxidation catalyst is located in the exhaust pathway, downstream from the first oxidation catalyst. Further, the first oxidation catalyst is usually operated at a temperature above a minimum temperature required for the oxidation of CO, such as temperature within the range of from about 700° F. to about 1200° F.

The first and the second oxidation catalysts can be the same or they can be different. Often, the first, the second or both oxidation catalysts include one or more platinum group metals.

In some situations, the method further includes determining levels of formaldehyde generated by the RICE, at least one location selected from the group consisting of: before the first oxidation catalyst, between the first and second oxidation catalysts and after the second oxidation catalyst.

In general according to another aspect, the invention features NG or methane fired stationary RICE system. The system comprises an NG or methane fired stationary RICE, a first oxidation catalyst disposed in a pathway for exhausting products of combustion from the NG or methane fired stationary RICE, and a second oxidation catalyst disposed in said pathway, downstream from the first oxidation catalyst.

In embodiments, the NG or methane fired stationary RICE is a lean burn engine.

In general, according to another aspect, the invention features a system for reducing HCOH emissions. This system comprises an NG or methane fired stationary RICE, a first oxidation catalyst disposed in a pathway for exhausting products of combustion from the NG or methane fired stationary RICE, and a second oxidation catalyst disposed in said pathway, downstream from the first oxidation catalyst.

In general, according to still another aspect, the invention features method for reducing HCOH emissions from an NG or methane fired stationary RICE. This method comprises oxidizing CO present in exhaust generated from the RICE and oxidizing HCOH present after the oxidation of CO.

In general, according to still another aspect, the invention features a method for reducing HCOH emissions from an NG or methane fired non-stationary RICE. This method comprises directing exhaust from the NG or methane fired RICE to a first oxidation catalyst, then to a second oxidation catalyst, the RICE being located in a vehicle, equipment, or vessel.

The second oxidation catalyst is operated at a temperature that is above a minimum temperature required for the oxidation of HCOH, and below a minimum temperature required to form HCOH.

In general, according to still another aspect, the invention features a NG or methane fired non-stationary RICE system. The system comprises an NG or methane fired stationary RICE that is located in a vehicle, equipment, or vessel, a first oxidation catalyst disposed in a pathway for exhausting products of combustion from the NG or methane fired stationary RICE, and a second oxidation catalyst disposed in said pathway, downstream from the first oxidation catalyst.

Practicing the invention has significant health and safety implications and can reduce or eliminate detectable levels of formaldehyde; acetaldehyde and other HAPs and VOCs from the exhaust of NG or methane fired stationary RICE engines, in particular in the lean burn mode. Implementations described here can contribute to compliance with relevant regulatory requirements. In many of its aspects, the invention presents a simple abatement approach allowing for an easy retrofit of existing RICE facilities, vehicles, equipment, and vessels. Concepts described herein also can be incorporated in new construction without major costs implications or overhaul of the basic design.

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a correlation plot of HCOH concentration, measured by Fourier transform infrared (FTIR) spectrometry, to CO concentration obtained post oxidation catalyst from a conventional NG fired lean burn stationary RICE.

FIG. 2 is a corrected correlation plot based on the data of FIG. 1

FIG. 3 is a correlation plot of HCOH concentration, measured by FTIR spectrometry, to VOCs concentration obtained post oxidation catalyst from a conventional NG fired lean burn stationary RICE.

FIG. 4 is a schematic diagram of one embodiment of the invention.

FIG. 5 is a picture of two oxidation catalyst cores, with two different lengths.

FIG. 6 is a picture of an experimental arrangement utilized in obtaining data.

FIG. 7 presents FTIR spectrometric information for formaldehyde concentrations and other gases generated by a natural gas fired RICE after primary catalysis.

FIG. 8 is a series of plots of % HCOH remaining after use of an oxidation catalyst as a function of temperature and flow rate.

FIGS. 9A and 9B are pictures of the experimental device utilized to evaluate a secondary oxidation catalyst placed in the exhaust of an operating NG fired stationary RICE.

FIG. 10 is a plot of the formaldehyde concentration obtained from an NG fired stationary RICE operated with and without a secondary oxidation catalyst.

### DETAILED DESCRIPTION OF THE PREFERRED EMBODIMENTS

NG-fired RICE often are found in oil production facilities for well drilling or hydraulic fracturing, in compressor stations along NG transmission lines, small power plants, electrical grid peaking plants, in facilities where NG-based combustion processes are economical or technically attractive, or in other applications including other stationary RICE and non-stationary RICE.

Emissions from RICE are of considerable concern, especially in light of National Emission Standards for Hazardous Air Pollutants (NESHAP) applicable to stationary internal combustion engines. Collectively, RICE sources can have a significant impact on air quality and public health. Air pollutants emitted from stationary engines can include acrolein, acetaldehyde, formaldehyde and methanol, as well as the more conventional air pollutants associated with fuel combustion such as carbon monoxide (CO), nitrogen oxides (NOₓ), sulfur oxides (SOₓ) volatile organic compounds (VOCs), hazardous air pollutants, particulate matter (PM) and so forth. These substances can cause irritations of the eyes, skin, mucous membranes, central nervous system, respiratory problems such as asthma, and/or other medical conditions.

Various approaches such as catalytic converters, specific engine configurations, combustion parameters (e.g., temperature, air and/or fuel flows, pressures, and so forth), use of oxygen-enriched air, lean combustion, fuel injected to exhaust, selective catalytic reduction (SCR) and non-selective catalytic reduction (NSCR), other techniques and/or combinations of different techniques can be employed or adapted to mitigate air pollutants such as NOₓ, SOₓ and/or other contaminants.

For example, a combustion process is considered “lean” when fuel is introduced into an engine with excess air. According to a more formal approach used in regulatory provisions, a “lean” burn engine refers to any two-stroke or four-stroke spark ignited engine that does not meet the definition of a rich burn engine. Rich burn engines are any four-stroke spark ignited engines where the manufacturer recommends an operating air/fuel ratio divided by the stoichiometric air/fuel ratio at full load conditions of less than or equal to 1.1. In this context, the stoichiometric air/fuel ratio is the theoretical air-to-fuel ratio required for complete combustion. Engines originally manufactured as rich burn engines, but modified prior to Dec. 19, 2002 with passive emission control technology for NOₓ (such as pre-combustion chambers) are considered lean burn engines. Existing engines where there are no manufacturer's recommendations regarding air/fuel ratio are to be considered a rich burn engine if the excess oxygen content of the exhaust at full load conditions is less than or equal to 2 percent. Therefore, in general, for the purposes of this description, unless defined otherwise, a lean-burn RICE is characterized by an excess oxygen content (diatomic or otherwise free oxygen) in the exhaust at full load conditions that is greater than 2 percent by volume.

Often efficient (capable of generating, for instance, more power for the same amount of fuel), the excess air present in lean burn engines tends to lower the combustion temperature, thus reducing the amounts of NOₓ produced when compared to conventional natural gas engines.

NG fired RICE such as lean burn NG fired RICE also produce HCOH, VOCs and/or slip VOCs (unburned fuel). In many cases, HCOH is generated together with CO, in the incomplete oxidation of CH₄. One technique for the abatement of hydrocarbons, HCOH, and CO from the exhaust of lean-burn natural gas engines involves oxidation catalysts. Most such catalysts use a combination of platinum (Pt), rhodium (Rh), and palladium (Pd) as the catalytically active substance. The active metals are typically deposited on a metal monolithic substrate.

Generally, traditional oxidation treatment techniques place the oxidation catalyst on the exhaust train of lean burn NG fired RICE systems, where typical temperatures are higher than about 700°, for example within a range of from about 700° F. to about 1200° F. These relatively high temperatures are needed for the conversion of HC, VOCs and CO to CO₂.

According to conventional thinking, the approach described above is expected to reduce HCOH emitted from RICE systems to non-detectable levels.

Contrary to wide spread expectations, it was discovered, however, that significant levels of formaldehyde could be found after treatment with the typical oxidation catalyst placed at high temperatures on the exhaust train of a lean burn NG fired RICE arrangement. The technique that allowed detection of these persistent HCOH levels of formaldehyde was Fourier Transform Infrared (FTIR) spectrometry, a method that can analyze this chemical compound qualitatively as well as quantitatively.

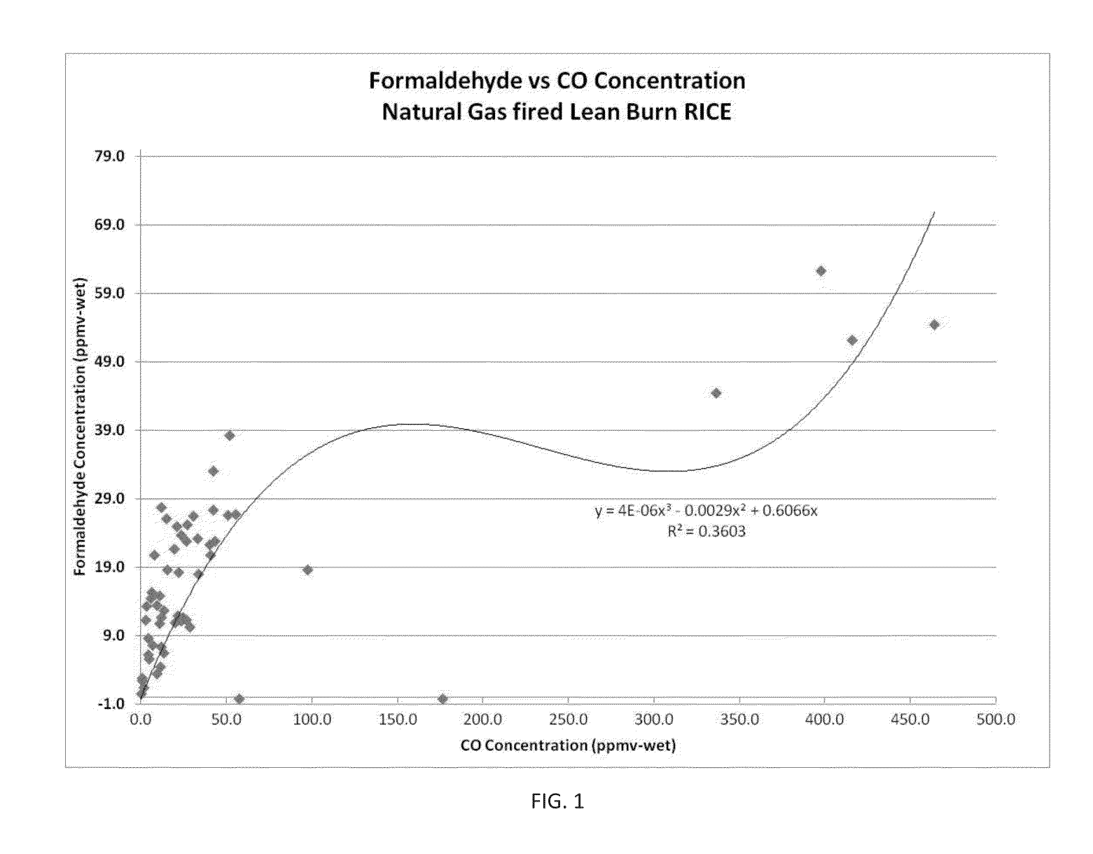

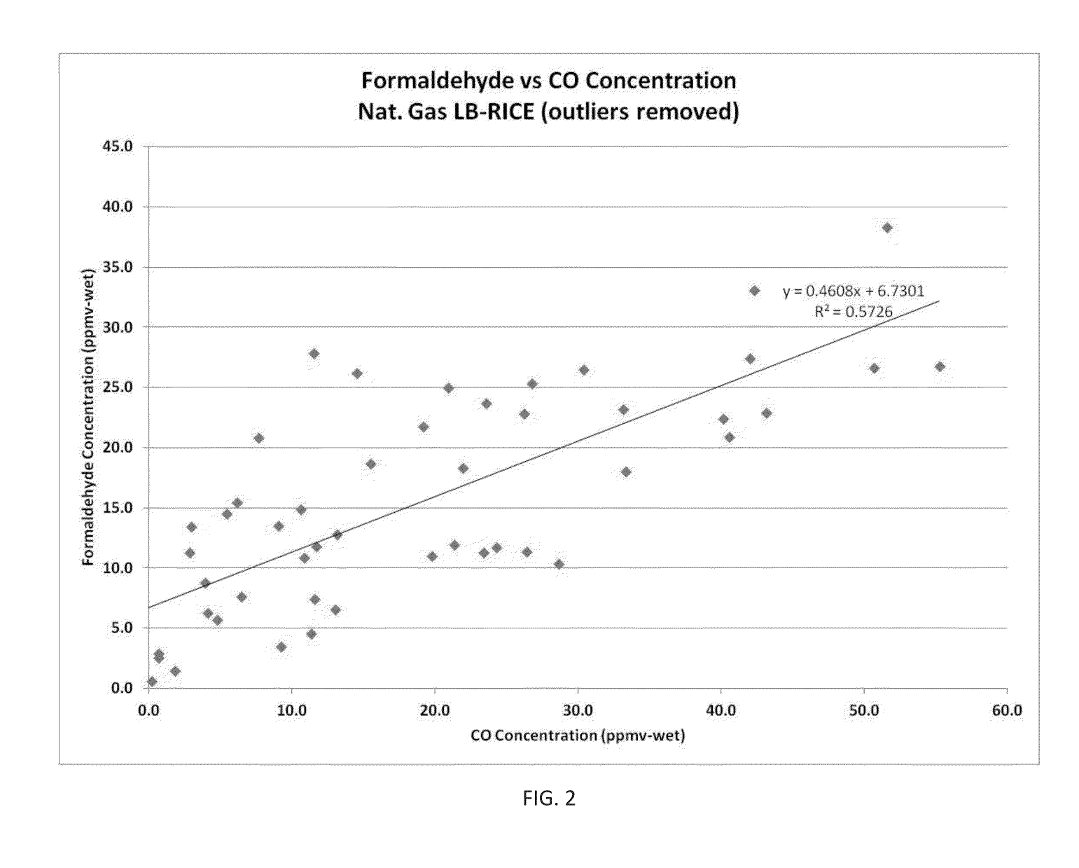

FIG. 1, for instance, is a correlation plot of HCOH concentration, measured by FTIR spectrometry, to CO concentration. As can be seen in this figure, the correlation is poor at best, even with a non-linear fit. An improvement in data presentation can be obtained by removing outliers from the plot (FIG. 2), giving a better linear R² correlation at 0.57. Importantly, however, the data indicate that formaldehyde is present after the oxidation catalyst, where, according to conventional expectations, HCOH levels should have been close to zero.

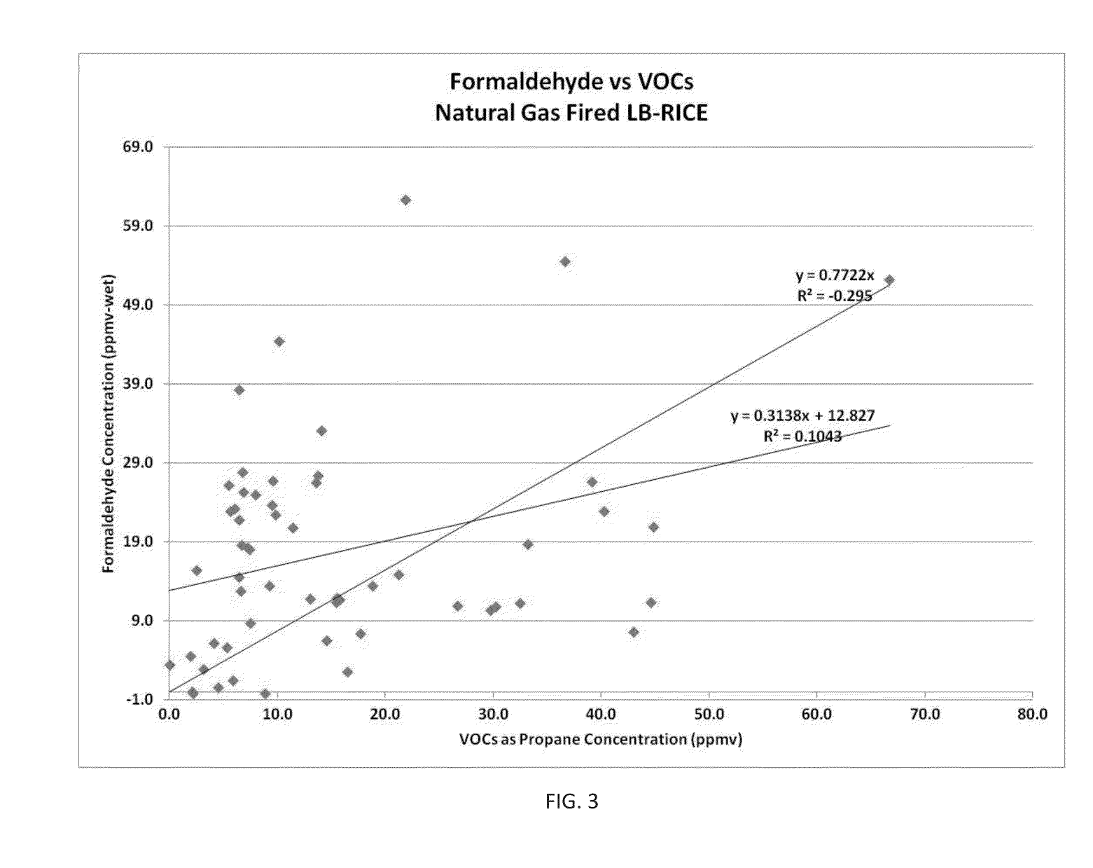

A somewhat better correlation occurs with VOCs (FIG. 3). Yet this plot also demonstrates the persistence of formaldehyde post catalytic treatment.

Without wishing to be bound by any particular interpretation, it was postulated that the relatively high temperatures (e.g., above 700° F., for example within the range of from about 700° F. to about 1000° F.), while facilitating the conversion of CO to CO₂, also promotes the formation of secondary HCOH from unconsumed CH₄ and O₂. Some reactions that may be relevant in this context are shown below:

1. CH₄+O₂+Spark Ignition→CO₂+H₂O+HCOH+other

2. CH₄+O₂+Heat (>1000° F.)+Catalyst→CO₂+H₂O+other

3. CH₄+O₂+Heat (700° F.-1000° F.)+Catalyst→HCOH+CO₂+H₂O

4. CH₄+O₂+Heat (<600° F.)+Catalyst→Very Minimal Reaction

5. HCOH+O₂+Catalyst Heat (>˜350° F.)→CO₂+H₂O

As already noted, the combustion of CH₄ from NG and O₂ from air produces CO₂, H₂O, HCOH and other species, e.g., VOCs, as shown in equation 1. As seen in equation 2, Temperatures above about 1000° F. in the presence of a catalyst promote the formation of CO₂, H₂O, and other materials. However, at temperatures in the range of 700° F.-1000° F., in the presence of a catalyst, CH₄ and O₂ generate HCOH, in addition to CO₂ and H₂O (equation 4). Equation 4 shows that below 600° F., the reaction between CH₄ and O₂ is very minimal. Finally, according to equation 5, HCOH can be oxidized in the presence of a catalyst at moderate heat, e.g., above ˜350° F. to form CO₂ and H₂O.

To address formaldehyde that is found post oxidation catalysis, exhaust from an NG or methane fired stationary RICE engine is directed to a first (also referred to herein as a primary) oxidation catalyst, then to a second (also referred to as secondary) oxidation catalyst. In many implementations, the RICE engine is a lean burn engine.

Typically, the primary oxidation catalyst is an oxidation catalyst traditionally utilized in the abatement of air pollutants generated by NG or methane fired stationary RICE engines, e.g., lean burn engines. In many situations, the primary catalyst is provided as a single catalytic device. The primary oxidation catalyst also can be provided as an arrangement (e.g., a cartridge, kit or another type of assembly) that includes two or more catalytic devices. To address partially oxidized species such as CO and HCOH, the primary oxidation catalyst is operated or maintained at conditions that promote or facilitate the reaction of these species with O₂, to generate CO₂ and H₂O. In specific implementations, the first oxidation catalyst is operated at a temperature above a minimum temperature required to convert, in the presence of O₂, CO, CxHy (hydrocarbons) and HCOH to CO₂ and H₂O.

This minimum temperature and/or optimal operating ranges can be determined experimentally, for instance, by in situ measurements or can be based on historical data obtained in a specific facility. Manufacturer recommendations, information available in the art and/or other means for determining threshold and optimized temperatures for the chemical reactions of interest also can be utilized.

Many primary oxidation catalysts are operated at temperatures within the range of from about 700° F. to about 1200° F. In specific examples, the first oxidation catalyst is placed in the pathway of the RICE exhaust, at a location where the exhaust typically has the desired temperature.

The second oxidation catalyst can be any conventional or newly developed catalyst suitable for the oxidation of formaldehyde. It can be of the same type as the first or it can be different.

Examples of secondary oxidation catalysts that can be utilized include but are not limited to catalysts containing one or more platinum group metals (Pt, Pd, Rh, Ru). Other types of oxidation catalysts that promote the conversion of HCOH to CO₂ and H₂O can be utilized. In many cases, the secondary catalyst can be selected from those that are commercially available. Still others can be tailored to particular requirements of a given facility.

In specific implementations, the secondary catalyst and, optionally, the primary catalyst are typical catalysts used in the post-combustion technology that has been applied to oxidize CO and hydrocarbons in engine exhaust, typically generated from lean-burn, where the combustion conditions tend to increase CO emissions. Such catalysts use a noble metal and can have efficiencies of approximately 70% for two stroke lean burn (2SLB) engines and 90% percent for four stroke lean burn (4SLB) engines with respect to the oxidation of CO to CO₂.

Non selective catalytic reduction (NSCR) devices designed for exhaust emissions from lean-burn natural gas, propane, or dual-fuel industrial engines also can be utilized. In many cases, these catalysts are designed to bring several types of contaminants such as CO, hydrocarbons (HC), VOCs, aldehydes, and other hazardous air pollutants (HAPs) to acceptable levels if, with use, the secondary catalyst becomes less effective (for instance by deactivation of the precious metal through the formation of oxide or phosphate coatings), it can be regenerated or replaced, using, for instance, known approaches.

The secondary oxidation catalyst can be configured (e.g., with respect to size, catalytic species, nature of the support (when present), mechanical parameters, shape, optimal operating temperatures and so forth) to balance various considerations related to a specific RICE system, while also enhancing elimination of HCOH. For example, the secondary catalyst can be tailored to fit specific space requirements and/or brands of catalytic converters. In one implementation, the secondary catalyst is shaped as a ring. In many situations, the second catalyst is provided as a single catalytic device. It also can be provided as an arrangement (e.g., a cartridge, kit or another type of assembly) that includes two or more catalytic devices.

In specific implementations, the second oxidation catalyst is maintained or operated at conditions that do not promote or facilitate formation of HCOH from CH₄ and O₂ yet promote or facilitate the oxidation of HCOH to CO₂ and H₂O. In specific implementations, the secondary oxidation catalyst is operated at a temperature that is lower than a minimum temperature required to re-form or generate HCOH from CH₄ and O₂. In other implementations, the second oxidation catalyst is maintained at a temperature that is higher than a minimum temperature required to oxidize HCOH to H₂O and CO₂. Thus the secondary oxidation catalyst can be exposed to exhaust temperatures that promote the oxidation of HCOH (to CO₂ and H₂O), but are not high enough to favor (re)generation of HCOH (from CH₄ and O₂), as seen with the primary catalyst.

Minimum temperatures and/or optimal operating ranges for the second oxidation catalyst can be determined experimentally, for instance, by in situ measurements or can be based on historical data obtained in a specific facility. Operating recommendations, information available in the art and/or other means for determining threshold and optimized temperatures for the chemical reactions of interest also can be utilized.

In many cases, the secondary oxidation catalyst is held at or exposed to a temperature that is no greater than about 700° F., for example, it is no greater than about 675° F., 650° F., 625° F., 600° F., 575° F., 550° F., 525° F., 500° F., 475° F., 450° F., 425° F., 400° F., 375° F., 350° F., 325° F., 300° F. or lower. In specific embodiments, the secondary oxidation catalyst is exposed to exhaust at temperatures between about 350° F. and 700° F., such as, for instance between 350° F. and 450° F. A suitable placement for the secondary oxidation catalyst is downstream of the primary oxidation catalyst, e.g., at a position along the exhaust pathway where the temperature of the exhaust has dropped to the desired temperature (e.g., 700° F. or less, for example within the range of 350° F.-450° F.).

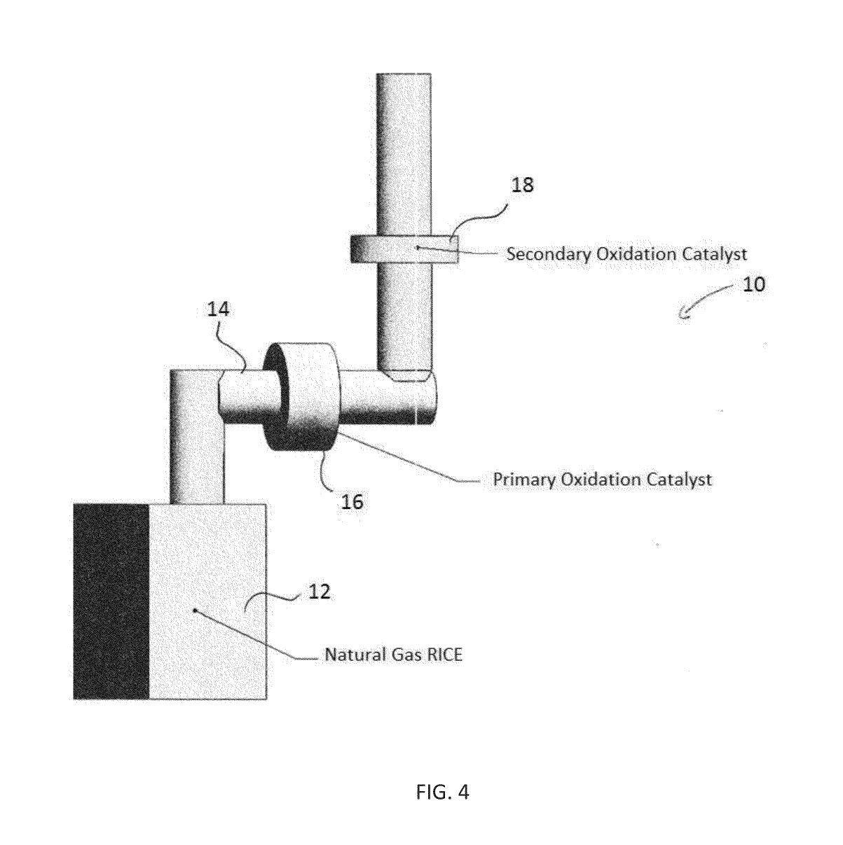

Shown in FIG. 4, for instance is a schematic diagram of NG or methane fired RICE system 10, including RICE 12 and exhaust conduit 14. A conventional configuration is used for primary oxidation catalyst 16, exposing this catalyst to temperatures that promote oxidation of HC, VOCs, CO and HCOH but also formation of secondary formaldehyde from the partial oxidation of any unburned methane exiting the engine. Secondary oxidation catalyst 18 is used to oxidize formaldehyde in the exhaust generated by first oxidation catalyst 16 and is placed downstream from the former, typically farther from RICE 12, in a zone where the exhaust stream has cooled to a temperature low enough to prevent or minimize re-formation of HCOH from unconsumed methane, yet warm enough to promote the oxidation of HCOH.

The system and method described herein can further include techniques and devices for measuring contaminant levels at various locations along the exhaust pathway, for instance, at locations before the first oxidation catalyst, between the first and second oxidation catalysts, after the second oxidation catalyst and/or at or near a point where the exhaust enters the ambient atmosphere. In one implementation, HCOH is monitored at one or more locations using FTIR spectrometry.

Alternatively or in addition to the secondary oxidation catalyst described above, HCOH found in exhaust downstream of the primary oxidation catalyst can be removed by other means, including, for example, other catalytic processes, chemical reactions, scrubbing, adsorption or absorption techniques and/or equipment.

Embodiments described herein are particularly well suited to applications in the oil and gas industry and can be used to retrofit existing NG-fired stationary RICE systems or can be incorporated in new designs and/or non stationary RICE systems. Similar approaches can be employed in other facilities or environments that run NG-fired stationary RICE systems, in particular RICE systems designed for lean burn mode.

Problems recognized and addressed with respect to stationary RICE also can be encountered in other types of internal combustion engines, both stationary and non-stationary, that are fueled by NG (pressurized or liquefied) or methane. Principles described herein can be applied or adapted to reduce HCOH emissions from such engines. On the subject of non-stationary RICE, for example, many buses are currently fueled by CH₄. Other existing or potential uses include non-stationary RICEs powered by NG, such as pressurized or liquefied NG, or CH₄ in vehicles (e.g., cars, buses, and trucks), construction and mining equipment, and vessels (e.g., ships and boats). If the existing (primary) catalyst aimed at abating atmospheric pollutants is exposed to conditions that promote re-formation of formaldehyde (from CH₄ and O₂), a secondary catalyst can be installed at a location where the conditions of the exhaust promote oxidation of HCOH to CO₂ and H₂O, without also promoting or facilitating the reaction of CH₄ and O₂ to re-form HCOH.

The following non-limiting examples are provided to illustrate principles of the invention.

### EXAMPLE 1

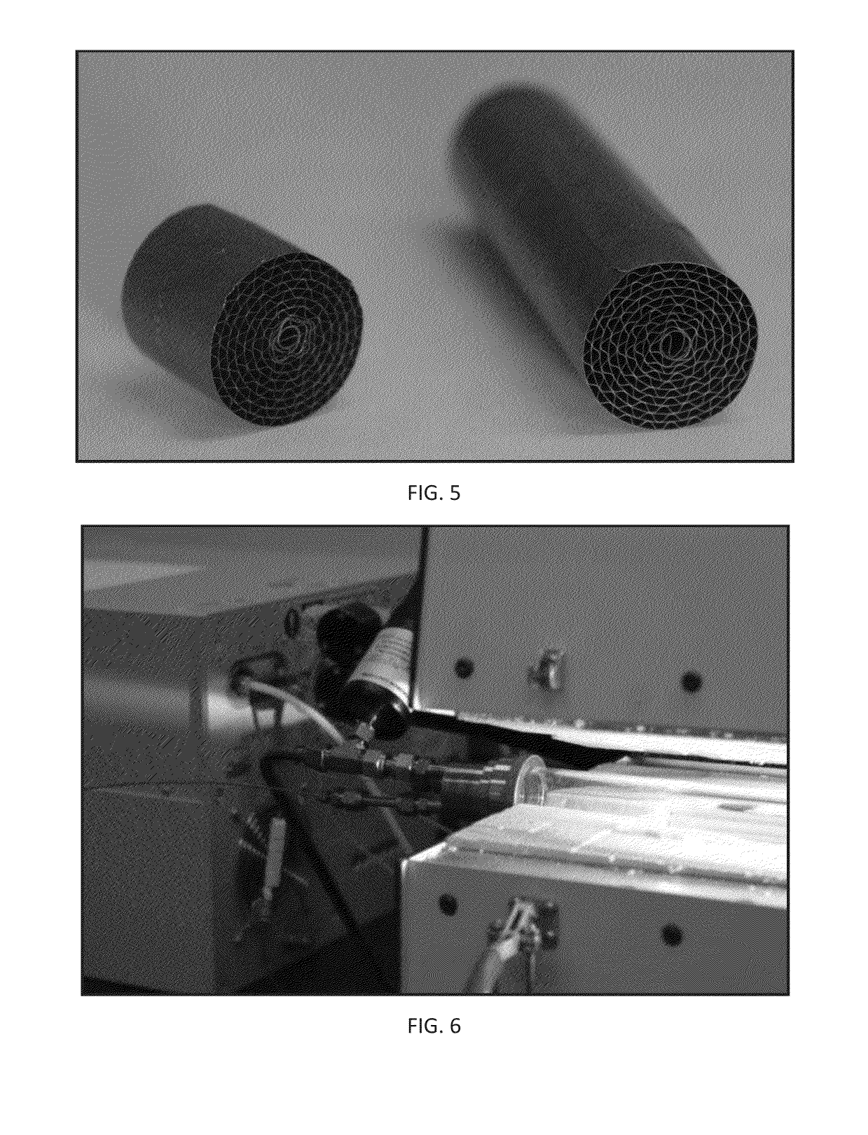

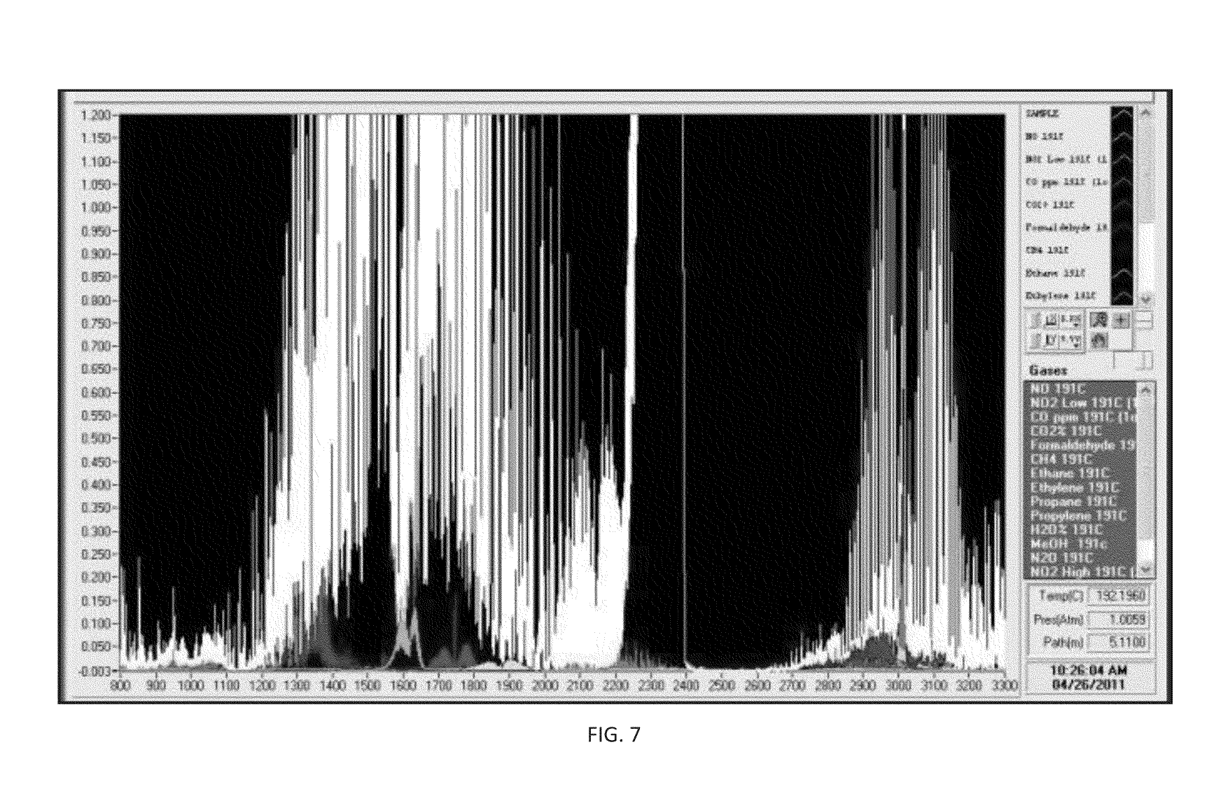

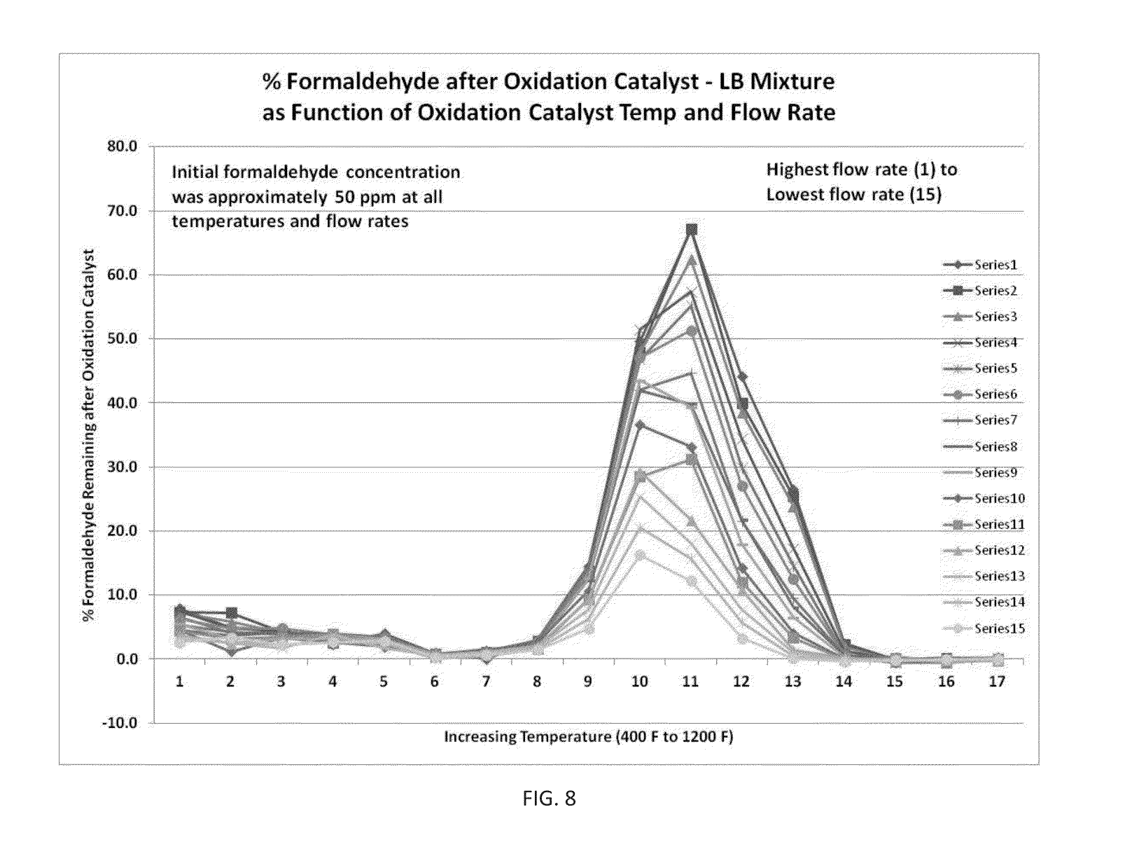

Simulated experiments were conducted on oxidation catalysts placed in a tube furnace capable of temperatures of up to 2000° F. with simulated engine exhaust at a large number of flow conditions and temperatures in the range of from about 400 to about 1200° F. A picture of two oxidation catalyst cores, with two different lengths is shown in FIG. 5; the experimental set-up is shown in FIG. 6. Infrared spectra were collected during this process and analyzed for formaldehyde concentrations when leaving the tube furnace shown in FIG. 7.

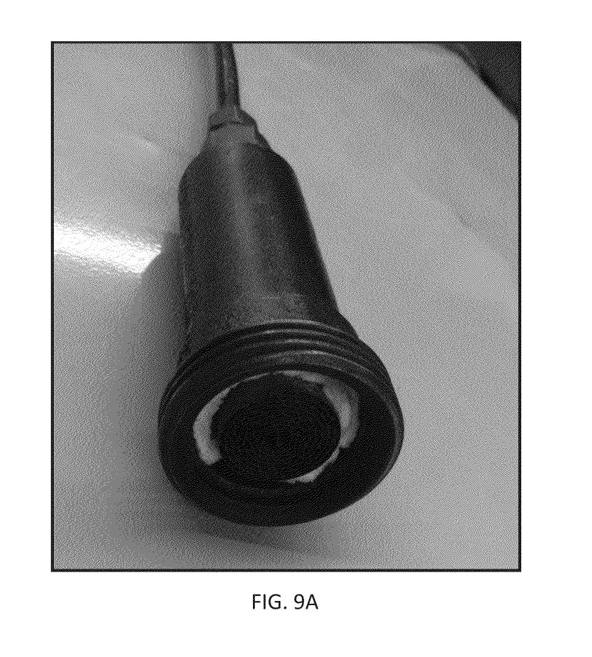

As can be seen in the plot of FIG. 8, very little formaldehyde as a percentage of the original concentration passed through the catalyst at the lower temperatures at the left side of the plot. Once the temperature of the oxidation catalyst reaches about 700° F., formaldehyde is once again seen as a percentage of the original gas mixture.

Further testing with mixtures not containing formaldehyde indicated that the same level of formaldehyde was observed in the post measured gas stream. This led to the conclusion that all (or most) of the original formaldehyde was being oxidized but that, at certain temperatures, the measured formaldehyde was formaldehyde being generated on the catalyst. FIG. 8, for instance, is a series of plots of % HCOH after use of an oxidation catalyst as a function of oxidation catalyst and flow rate. Additional tests with blank cores (no catalyst on the core structure) showed even higher formaldehyde concentrations, so this further demonstrated that the high surface area was causing partial oxidation of the methane to formaldehyde.

### EXAMPLE 2

To study whether formaldehyde could be reduced, a test was performed on a real engine that was exhibiting formaldehyde emission issues post oxidation catalyst. The test was conducted while trying to avoid interfering with the engine performance. A catalyst probe was designed to demonstrate the concept.

The stack was known to be about 425° F., a temperature believed to be in the correct zone for removing the post oxidation catalyst formaldehyde present if a catalyst was to be placed in this zone.

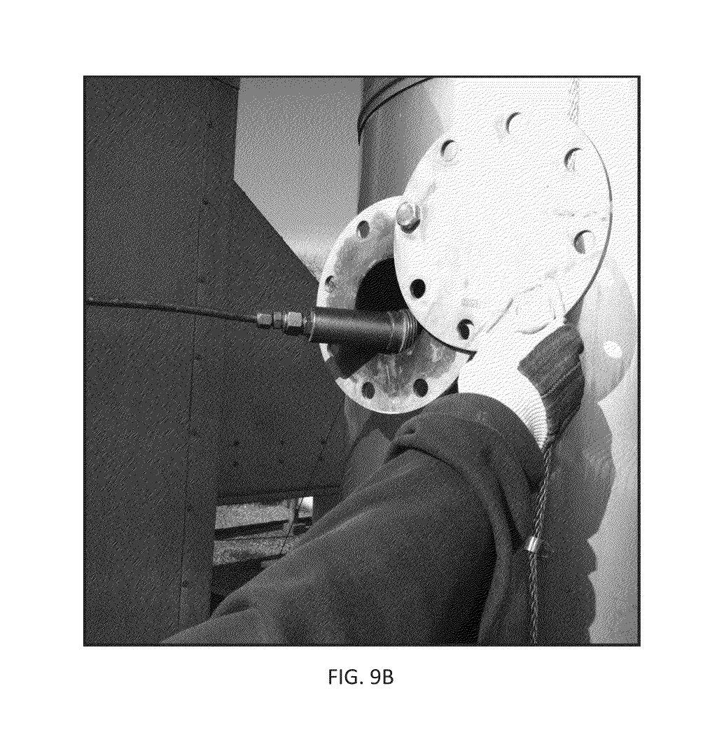

Only a portion of the exhaust was affected by the experiment. This portion was then drawn into a FTIR for formaldehyde testing. Shown in FIG. 9A is a picture of an oxidation catalyst core surrounded by insulation to ensure that it would tightly fit into a sampling probe so that all the gases sampled would have to go through the core. The picture of FIG. 9B shows the assembled probe entering the lean burn RICE exhaust stack.

The sample probe was inserted into a standard sampling port (as seen in FIG. 9B). The ⅜ stainless tubing was then connected to a heated transfer line that took the emission gases to the FTIR analyzer.

Since it was discovered that temperature appears to be very important to the reduction of formaldehyde, this parameter was measured at the sampling point to confirm that the temperature was indeed between 350 and 650° F., it was near 425° F.

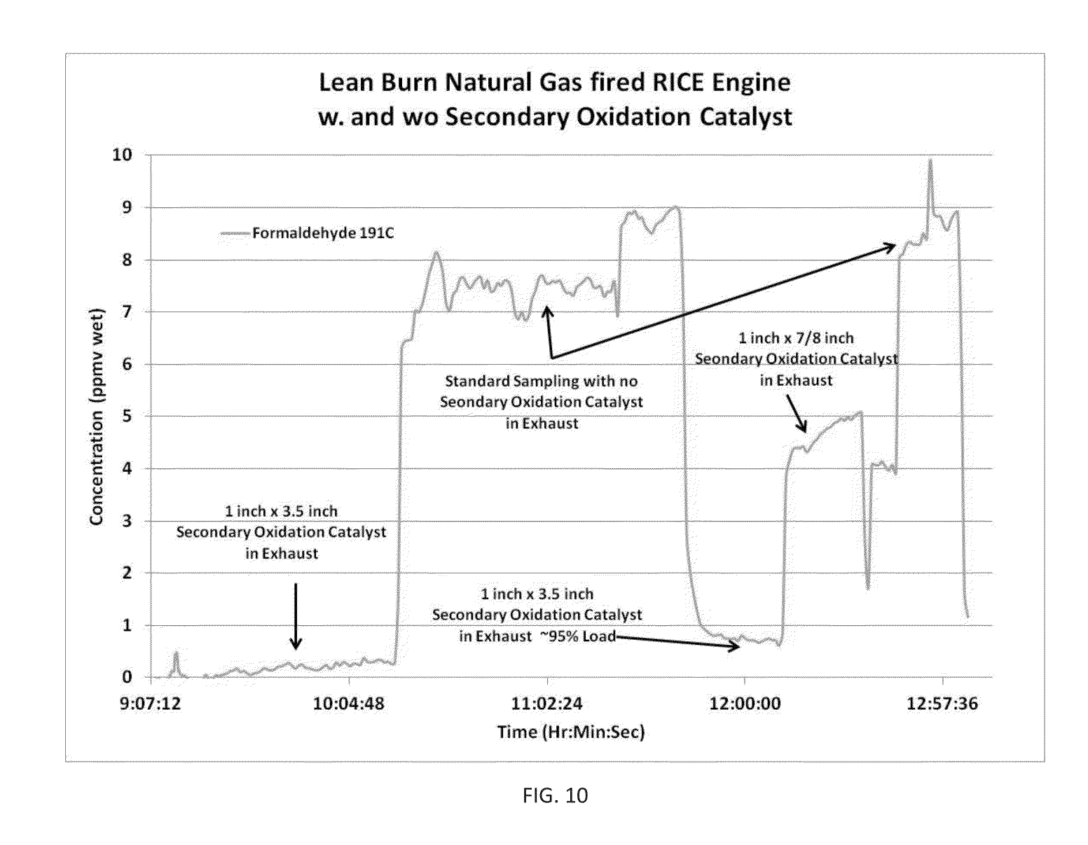

FIG. 10 is a plot of the formaldehyde concentration measured from exhaust port in FIG. 9B using different configurations. The first region of the plot has the second oxidation catalyst in the exhaust flow. Then this catalyst was removed and the exhaust was measured without any further sample treatment. Since the engine was still spinning up to full load, the second catalyst was again placed in the exhaust and the formaldehyde was again measured and reduction in formaldehyde was observed. To follow up, a shorter core was placed into the probe to evaluate whether length mattered at the flow rates that were used and a much higher formaldehyde emission was observed. Finally the catalyst was again removed to show the final formaldehyde concentration from the exhaust.

The results of these experiments showed that a second oxidation catalysts, held at a temperature lower than the first oxidation catalyst, disposed, for example, in a region where exhaust is cooling off reduced secondary formaldehyde generated on the first oxidation catalyst. The results also suggested that formaldehyde removal could be optimized by adjustments in the configuration and/or design of the second oxidation catalyst.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for reducing HCOH emissions from an NG or methane fired stationary RICE, the method comprising:
directing exhaust from the NG or methane fired stationary RICE to a first oxidation catalyst, then to a second oxidation catalyst,
wherein the second oxidation catalyst is operated at a temperature that is above a minimum temperature required for the oxidation of HCOH, and below a minimum temperature required to form HCOH.

2. The method of claim 1, wherein the NG or methane fired stationary RICE is a lean burn engine.

3. The method of claim 1, wherein the second oxidation catalyst is exposed to exhaust at a temperature within the range of from about 350° F. to about 700° F.

4. The method of claim 1, wherein the secondary oxidation catalyst is located in the exhaust pathway, downstream from the first oxidation catalyst.

5. The method of claim 1, wherein the first oxidation catalyst is operated at a temperature above a minimum temperature required for the oxidation of CO.

6. The method of claim 1, wherein the first oxidation catalyst is exposed to a temperature within the range of from about 700° F. to about 1200° F.

7. The method of claim 1, wherein the first and the second oxidation catalysts are the same.

8. The method of claim 1, wherein the first and the second oxidation catalysts are different.

9. The method of claim 1, wherein the first, the second or both oxidation catalysts include one or more platinum group metals.

10. The method of claim 1, further comprising determining levels of formaldehyde generated by the RICE at at least one location selected from the group consisting of:
before the first oxidation catalyst, between the first and second oxidation catalysts and after the second oxidation catalyst.

11. An NG or methane fired stationary RICE system, comprising:
a NG or methane fired stationary RICE;
a first oxidation catalyst disposed in a pathway for exhausting products of combustion from the NG or methane fired stationary RICE; and
a second oxidation catalyst disposed in said pathway, downstream from the first oxidation catalyst.

12. The system of claim 11, wherein the NG or methane fired stationary RICE is a lean burn engine.

13. The system of claim 11, wherein the second oxidation catalyst is disposed at a location where it can be exposed to a temperature higher than a minimum temperature required for the oxidation of HCOH.

14. The system of claim 11, wherein the second oxidation catalyst is disposed at a location where it can be exposed to a temperature lower than a minimum temperature required for the formation of HCOH.

15. The system of claim 11, wherein the first oxidation catalyst is disposed at a location where it can be exposed to a temperature higher than a minimum temperature required for the oxidation of CO.

16. The system of claim 11, wherein the first oxidation catalyst is exposed to a temperature within the range of from about 700° F. to about 1200° F.

17. The system of claim 11, wherein the second oxidation catalyst is exposed to a temperature within the range of from about 350° F. to about 700° F.

18. The system of claim 11, wherein the first and the second oxidation catalysts are the same.

19. The system of claim 11, wherein the first and the second oxidation catalysts are different.

20. The system of claim 11, wherein the first, the second or both oxidation catalysts include one or more platinum group metals.

21. A system for reducing HCOH emissions, the system comprising:
an NG or methane fired stationary RICE;
a first oxidation catalyst disposed in a pathway for exhausting products of combustion from the NG or methane fired stationary RICE; and
a second oxidation catalyst disposed in said pathway, downstream from the first oxidation catalyst.

22. A method for reducing HCOH emissions from an NG or methane fired RICE, the method comprising:
oxidizing CO present in exhaust generated from the RICE; and
oxidizing HCOH present after the oxidation of CO.

23. The method of claim 22, wherein at least a portion of the HCOH is formed by the reaction of CH₄ and O₂ at temperatures at which CO present in the exhaust generated by RICE is oxidized.

24. The method of claim 22, wherein step (a) is conducted in the presence of a first oxidation catalyst.

25. The method of claim 22, wherein step (b) is conducted in the presence of an oxidation catalyst.

26. The method of claim 22, wherein the RICE is a lean burn engine.

27. The method of claim 22, further comprising monitoring levels of HCOH.

28. A method of claim 22, wherein the RICE is stationary.

29. A method for reducing HCOH emissions from an NG or methane fired non-stationary RICE, the method comprising:
directing exhaust from the NG or methane fired RICE to a first oxidation catalyst, then to a second oxidation catalyst, the RICE being located in a vehicle, equipment, or vessel,
wherein the second oxidation catalyst is operated at a temperature that is above a minimum temperature required for the oxidation of HCOH, and below a minimum temperature required to form HCOH.

30. An NG or methane fired non-stationary RICE system, comprising:
an NG or methane fired stationary RICE that is located in a vehicle, equipment, or vessel;
a first oxidation catalyst disposed in a pathway for exhausting products of combustion from the NG or methane fired stationary RICE; and
a second oxidation catalyst disposed in said pathway, downstream from the first oxidation catalyst.
